(19) United States
(12) Patent Application Publication
(10) Pub. No.: US 2024/0324051 A1
(43) Pub. Date: Sep. 26, 2024

(54) DEVICE AND METHOD FOR SIGNAL TRANSMISSION IN NETWORK ACCORDING TO SEPARATION OF UPF FUNCTION SPLIT IN WIRELESS COMMUNICATION SYSTEM

(71) Applicant: Samsung Electronics Co., Ltd., Suwon-si (KR)

(72) Inventors: Daejoong KIM, Suwon-si (KR); Hyunjeong LEE, Suwon-si (KR)

(21) Appl. No.: 18/737,155

(22) Filed: Jun. 7, 2024

Related U.S. Application Data
(63) Continuation of application No. PCT/KR2022/020761, filed on Dec. 20, 2022.

(30) Foreign Application Priority Data
Jan. 5, 2022 (KR) 10-2022-0001607

(51) Int. Cl. H04W 76/22; H04W 76/12; H04W 76/23

(52) U.S. Cl. CPC H04W 76/22; H04W 76/12; H04W 76/23

(57) ABSTRACT

The disclosure relates to a 4th generation (4G) communication system such as Long Term Evolution (LTE), and a 5th generation (5G) or pre-5G communication system for supporting higher data transmission rates than 4G communication systems. A method performed by a session management function (SMF) device in a wireless communication system is provided. The method includes receiving, by the SMF device, a protocol data unit (PDU) session establishment request message from an access and mobility management function (AMF), transmitting, by the SMF device, a PDU session establishment response message to the AMF, transmitting, by the SMF device, a first session establishment request message to a user plane function (UPF) anchor, receiving, by the SMF device, a first session setup establishment message from the UPF anchor, transmitting, by the SMF device, a second session establishment request message to a radio access gateway (RAG), and receiving, by the SMF device, a second session establishment response message from the RAG, wherein the RAG includes a central unit (CU)-user plane (UP) and a UPF edge.

### CROSS-REFERENCE TO RELATED APPLICATION(S)

This application is a continuation application, claiming priority under § 365(c), of an International application No. PCT/KR2022/020761, filed on Dec. 20, 2022, which is based on and claims the benefit of a Korean patent application number 10-2022-0001607, filed on Jan. 5, 2022, in the Korean Intellectual Property Office, the disclosure of which is incorporated by reference herein in its entirety.

### BACKGROUND

### 1. Field

The disclosure relates to a wireless communication system. More particularly, the disclosure relates to an apparatus and a method for signal transmission in a network according to function split of a user plane function (UPF) in a wireless communication system.

### 2. Description of Related Art

To meet the demand for wireless data traffic having increased since deployment of 4th generation (4G) communication systems, efforts have been made to develop an improved 5th generation (5G) or pre-5G communication system. Therefore, the 5G communication system is also called a “beyond 4G network” communication system or a “post long term evolution (post LTE) system”.

The 5G communication system is considered to be implemented in ultrahigh frequency (mmWave) bands, (e.g., 28 GHz bands) so as to accomplish higher data rates. To decrease the propagation loss and increase the transmission distance of radio waves in the mmWave bands, beamforming, massive multiple-input multiple-output (MIMO), full dimensional MIMO (FD-MIMO), array antenna, an analog beam forming, and large scale antenna techniques have been discussed in the 5G communication system.

In addition, in the 5G communication system, technical development for system network improvement is under way based on advanced small cells, cloud radio access networks (cloud RANs), ultra-dense networks, device-to-device (D2D) communication, wireless backhaul, moving network, cooperative communication, coordinated multi-points (COMP), reception-end interference cancellation, and the like.

In the 5G system, hybrid frequency shift keying (FSK) and quadrature amplitude modulation (QAM) (FQAM) and sliding window superposition coding (SWSC) as an advanced coding modulation (ACM) scheme, and filter bank multi carrier (FBMC), non-orthogonal multiple access (NOMA), and sparse code multiple access (SCMA) as an advanced access technology have also been developed.

‘Software defined networking (SDN)’ refers to a technology that separates a control area from individual network elements (NEs) configuring a network, by using accessible devices, and logically controls and manages the network by using applications in the accessible devices. 3GPP has introduced the concept of SDN to a 5G mobile network by performing separation between a control plane and a user plane.

The above information is presented as background information only to assist with an understanding of the disclosure. No determination has been made, and no assertion is made, as to whether any of the above might be applicable as prior art with regard to the disclosure.

### SUMMARY

Aspect of the disclosure are to address at least the above-mentioned problems and/or disadvantages and to provide at least the advantages described below. Accordingly, an aspect of the disclosure is to provide an apparatus and a method for a radio access gateway (RAG) in which a part of a user plane function (UPF) are integrated with a central unit (CU)-control plane (CP) in a wireless communication system.

Another aspect of the disclosure is to provide an apparatus and a method for signal transmission in a network architecture separated into a UPF edge and a UPF anchor, according to function split of a UPF in a wireless communication system.

Another aspect of the disclosure is to provide an apparatus and a method for session setup of a core network in a network according to UPF function split in a wireless communication system.

Another aspect of the disclosure is to provide an apparatus and a method for supporting mobility of a core network in a network according to UPF function split when a terminal is handed over in a wireless communication system.

Another aspect of the disclosure is to provide an apparatus and a method for generating a tunnel between UPFs separated from a network according to UPF function split in a wireless communication system.

Additional aspects will be set forth in part in the description which follows and, in part, will be apparent from the description, or may be learned by practice of the presented embodiments.

In accordance with an aspect of the disclosure, a method performed by a session management function (SMF) device in a wireless communication system is provided. The method includes receiving, by the SMF device, a protocol data unit (PDU) session setup request message from an access and mobility management function (AMF), transmitting, by the SMF device, a PDU session setup response message to the AMF, transmitting, by the SMF device, a first session setup request message to a user plane function (UPF) anchor, receiving, by the SMF device, a first session setup response message from the UPF anchor, transmitting, by the SMF device, a second session setup request message to a radio access gateway (RAG), and receiving, by the SMF device, a second session setup response message from the RAG, wherein the RAG includes a central unit (CU)-user plane (UP) and a UPF edge.

In accordance with another aspect of the disclosure, an apparatus performed by a session management function (SMF) device in a wireless communication system is provided. The apparatus includes at least one transceiver, memory storing one or more computer programs, and one or more processors communicatively coupled to the at least one transceiver and memory, wherein the one or more computer programs include computer-executable instructions that, when executed by the one or more processors, cause the apparatus to receive a protocol data unit (PDU) session setup request message from an access and mobility management function (AMF), transmit a PDU session setup response message to the AMF, transmit a first session setup request message to a user plane function (UPF) anchor, receive a first session setup response message from the UPF anchor, transmit a second session setup request message to a radio access gateway (RAG), and receive a second session setup response message from the RAG, and wherein the RAG includes a central unit (CU)-user plane (UP) and a UPF edge.

In accordance with another aspect of the disclosure, one or more non-transitory computer-readable storage media storing one or more computer programs including computer-executable instructions that, when executed by one or more processors of session management function (SMF) device, cause the SMF device to perform operations are provided. The operations include operations receiving, by the SMF device, a protocol data unit (PDU) session setup request message from an access and mobility management function (AMF), transmitting, by the SMF device, a PDU session setup response message to the AMF, transmitting, by the SMF device, a first session setup request message to a user plane function (UPF) anchor, receiving, by the SMF device, a first session setup response message from the UPF anchor, transmitting, by the SMF device, a second session setup request message to a radio access gateway (RAG), and receiving, by the SMF device, a second session setup response message from the RAG, wherein the RAG comprises a central unit (CU)-user plane (UP) and a UPF edge.

An apparatus and a method according to various embodiments of the disclosure can eliminate unnecessary Internet protocol (IP) packet manipulation and reduce packet latency through an architecture in which a mobility anchor function is split separately from a user plane function (UPF) and integrated with a central unit (CU)-user plane (UPF).

Other aspects, advantages, and salient features of the disclosure will become apparent to those skilled in the art from the following detailed description, which, take in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a core network according to an embodiment of the disclosure;

FIG. 1B illustrates a functional structure of a network node according to an embodiment of the disclosure;

FIG. 1C illustrates a communication network including a user plane function (UPF) according to an embodiment of the disclosure;

FIG. 2A illustrates a communication network including a separated UPF and a radio access gateway (RAG) according to an embodiment of the disclosure;

FIG. 2B illustrates various examples of a communication network including a RAG according to an embodiment of the disclosure;

FIG. 3 illustrates a user plane protocol layer of network entities according to an embodiment of the disclosure;

FIG. 4 shows an example of a functional structure of a RAG according to an embodiment of the disclosure;

FIG. 5 illustrates a signal flow of network entities for setting up a session according to an embodiment of the disclosure;

FIG. 6 illustrates an operation flow for session setup of a session management function (SMF) device according to an embodiment of the disclosure;

FIG. 7 illustrates handover associated with mobility support on a core network according to an embodiment of the disclosure;

FIG. 8 illustrates a signal flow of network entities for setting up a session in a handover process of a terminal according to an embodiment of the disclosure;

FIG. 9 illustrates an operation flow for session setup of a session management function (SMF) device in a handover process of a terminal according to an embodiment of the disclosure; and

FIG. 10 illustrates an example of a Gi-local area network (LAN) service included in a UPF according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, various embodiments of the disclosure will be described based on an approach of hardware. However, various embodiments of the disclosure include a technology that uses both hardware and software, and thus the various embodiments of the disclosure may not exclude the perspective of software.

This disclosure proposes an architecture of separated user plane function (UPF) and provides a method for signal transmission by each network entity on a core network. Although the disclosure proposes interfaces, core networks, and workflows, operations of entities defined as functions are not to be construed as limiting specific implementations.

With the introduction of 5G NR in a wireless communication system, a radio access network (RAN) and a core network (CN) have a separate structure in terms of standards and products. From the point of view of the communication service provider, the radio access network and the core network have been managed separately. However, in a technical aspect, since packets in a user plane (UP) are processed based on a user session, it may be advantageous for high communication performance to deploy the entity for managing a user plane of the RAN and the user plane function (UPF) of the CN together. Accordingly, the disclosure proposes an architecture in which at least a part of the user plane function (UPF) and the user plane of the RAN are integrated. Hereinafter, an architecture in which at least a part of the UPF is combined with a central unit (CU)-control plane (CP) of the RAN will be described, but embodiments of the disclosure are not limited thereto. The UPF is not limited to an architecture of integrating the user plane with the RAN, and may be deployed inside a digital unit (DU) or in an intermediate network function such as a cell site router (CSR).

A network structure based on user plane integration of the RAN and the core network (e.g., UPF) (hereinafter referred to as a UP integration-based core network) may simplify the wireless communication system to eliminate unnecessary IP packet manipulation and reduce packet latency. The user plane integration of the RAN and core network (e.g., UPF) allows user traffic to be transmitted through the UP integration-based core network instead of being transmitted through a cloud. A communication service provider may switch networks into cloud-based networks at a lower cost as user traffic is transmitted through the UP integration-based core network. The disclosure describes a technology for signal transmission of each node in a UP integration-based core network in a wireless communication system.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

Furthermore, various embodiments of the disclosure will be described using terms used in some communication standards (e.g., the 3rd generation partnership project (3GPP)), but they are for illustrative purposes only. The embodiments of the disclosure may be easily applied to other communication systems through modifications. Hereinafter, some terms used in the core network of the disclosure are predefined.
AMF Access and Mobility Management Function
CN Core Network
CNF Containerized Network Function
DNN Data Network Name
PCF Policy Control Function
HSS Home Subscriber Server
SMF Session Management Function
UDM User Data Management
UPF User Plane Function
CNF Containerized Network Function
VNF Virtual Network Function

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like

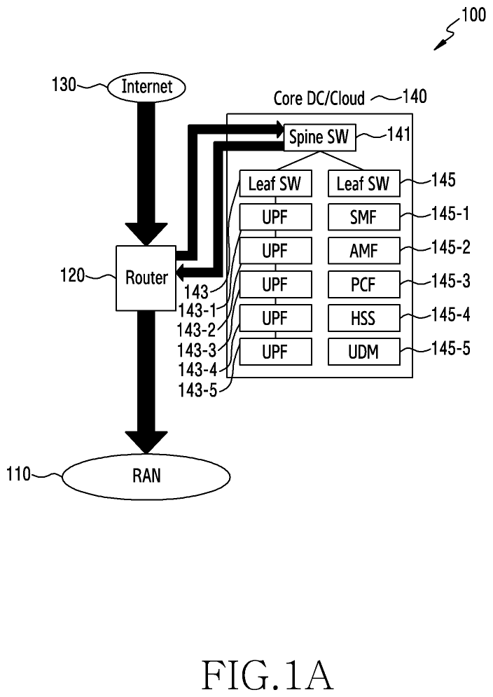

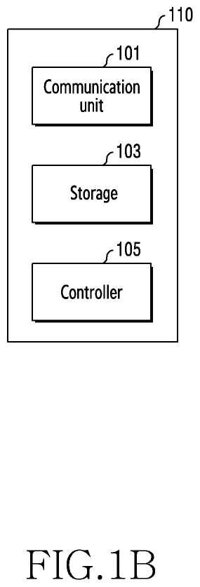

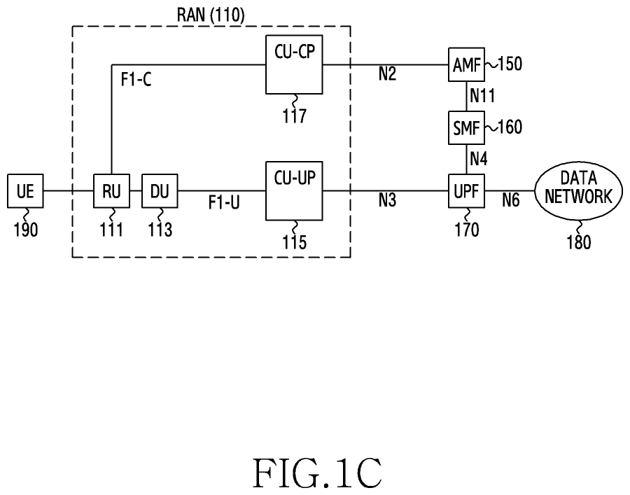

FIG. 1A illustrates a core network according to an embodiment of the disclosure.

A core network 100 is a communication system for forming a 5G network, and may include user plane functions (UPFs) 143-1, 143-2, 143-3, 143-4 and 143-5, an access and mobility management function (AMF) 145-2, a session management function (SMF) 145-1, a policy control function (PCF) 145-3, a user data management (UDM) 145-5, and a home subscriber server (HSS) 145-4.

Referring to FIG. 1A, a radio access network (RAN) node 110 may transmit and receive user traffic to and from the Internet (i.e., data network 180) via a core data center 140 via a router 120. The core data center 140 may be a cloud system. The cloud may refer to servers accessible through the Internet and the software and databases that operate on these servers. Recently, communication service providers are including a core network of a wireless communication system in their own data centers, such as a public cloud.

As shown in FIG. 1A, entities of the core network may be included in the core data center (i.e., a cloud) 140. A spine switch 141 and leaf switches 143 and 145 may configure a path of a core network entity required by user traffic. For example, when user traffic requires packet processing in the UPFs 143-1 to 143-5, the spine switch 141 and the leaf switches 143 and 145 configure a path for the UPF entity. However, when user traffic requires packet processing of the UPF in the data center 140, a large amount of cloud resources, including commercial off-the-shelf (COTS) servers, optic modules, switches, rack space, energy, virtualization software licenses, maintenance costs, and the like may be consumed.

According to various embodiments of the disclosure, deployment of the UPF entity in the RAN node 110 allows user traffic to be transmitted independently of the data center 140. According to various embodiments of the disclosure, deployment of the UPF entity in the RAN node 110 may make a wireless communication system simpler. UP integration-based core network may eliminate unnecessary IP packet manipulation and reduce packet latency. Since user traffic may not need to be routed through a data center (e.g., a cloud system) 140, cloud costs may be reduced.

FIG. 1B illustrates a functional configuration of a network node according to an embodiment of the disclosure.

A network node may refer to a device configured to perform one or more functional elements defined with reference to FIGS. 1A to 1C, 2A, 2B, and 3 to 10. For example, the description of an entity in FIG. 1B is logically defined, such as “function,” such that a device performing function A may be configured separately from a device performing function B, or a device performing function A may be implemented together with a device performing function B.

Referring to FIG. 1B, the network node includes a communication unit 101, a storage 103, and a controller 105. The communication unit 101 may perform functions for transmitting and receiving signals in a wireless communication environment. The communication unit 101 may include a wired interface for controlling a direct connection between devices through a transmission medium (e.g., a copper wire or an optical fiber). For example, the communication unit 101 transmits an electrical signal to another device through a copper wire, or perform conversion between an electrical signal and an optical signal.

Meanwhile, the communication unit 101 may perform functions for transmitting and receiving signals in a wireless communication environment. For example, the communication unit 101 performs a conversion function between a baseband signal and a bit string according to the physical layer standard of the system. For example, during data transmission, the communication unit 101 generates complex symbols by encoding and modulating a transmission bit stream. In addition, when receiving data, the communication unit 101 may restore a received bit stream by demodulating and decoding a baseband signal. In addition, the communication unit 101 may up-convert a baseband signal into a radio frequency (RF) band signal, transmit the signal through an antenna, and down-convert an RF band signal received through the antenna into a baseband signal. To this end, the communication unit 101 may include a transmission filter, a reception filter, an amplifier, a mixer, an oscillator, a digital to analog converter (DAC), an analog to digital converter (ADC), and the like. Furthermore, the communication unit 101 may include a plurality of transmission/reception paths. The communication unit 101 may be configured by a digital unit and an analog unit, and the analog unit may be configured by a plurality of sub-units according to operating power, operating frequency, and the like.

The communication unit 101 transmits and receives signals as described above. Accordingly, all or part of the communication unit 101 may be referred to as a ‘transmitter’, a ‘receiver’, or a ‘transceiver’. In addition, the transmission and reception conducted is used to embrace the above-described processing performed by the communication unit 101 in the following description.

The storage 103 may store data such as a basic program, an application program, and configuration information for the operation of the network node. The storage 103 may be configured by volatile memory, non-volatile memory, or a combination of volatile memory and non-volatile memory. In addition, the storage 103 may provide the stored data according to a request of the controller 105.

The controller 105 controls overall operations of the network node. For example, the controller 105 transmits and receives signals through the communication unit 101. Further, the controller 105 records and reads data in and from the storage 103. In addition, the controller 105 may perform protocol stack functions required by communication standards. To this end, the controller 105 may include at least one processor or microprocessor, or may be a part of the processor. In addition, a part of the communication unit 101 and the controller 105 may be referred to as a CP. The controller 105 may include various modules for performing communication.

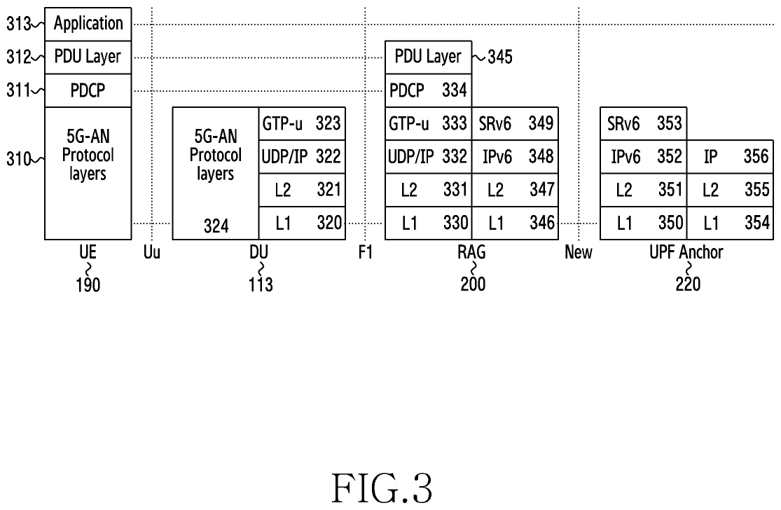

The configuration of the management device shown in FIG. 1B is only an example, and the configuration of the management device is not limited to the configuration shown in FIG. 3. That is, according to various embodiments, some configurations may be added, deleted, or changed.

An apparatus performed by a session management function (SMF) device in a wireless communication system according to embodiments of the disclosure may include at least one transceiver, and at least one processor functionally coupled to the at least one transceiver, wherein the at least one processor is configured to receive a protocol data unit (PDU) session setup request message from an access and mobility management function (AMF), transmit a PDU session setup response message to the AMF, transmit a first session setup request message to a user plane function (UPF) anchor, receive a first session setup response message from the UPF anchor, transmit a second session setup request message to a radio access gateway (RAG), and receive a second session setup response message from the RAG, wherein the RAG includes a central unit (CU)-user plane (UP) and a UPF edge.

According to an embodiment of the disclosure, the at least one processor may be further configured to transmit a session modification request message to the UPF anchor and receive a session modification response message from the UPF anchor.

According to an embodiment of the disclosure, the at least one processor may be further configured to receive a PDU session update request message from the AMF, transmit a third session setup request message to the target RAG, receive a third session setup response message from the target RAG, transmit a session modification request message to the UPF anchor, receive a session modification response message from the UPF anchor, and transmit a PDU session update response message to the AMF.

According to an embodiment of the disclosure, the at least one processor may be further configured to transmit a session deletion request message to a source RAG, and receive a session deletion response message from the source RAG.

According to an embodiment of the disclosure, the PDU session setup request message may include information capable of accessing the RAG.

According to an embodiment of the disclosure, the first session setup response message may include at least one of information on an Internet protocol (IP) address of a terminal or information of a tunnel connected between the RAG and the UPF anchor.

According to an embodiment of the disclosure, the second session setup response message may include context information about the terminal, information of a tunnel connected between the RAG and the UPF anchor, or information on a tunnel endpoint identifier (TEID) of the RAG.

According to an embodiment of the disclosure, the PDU session update request message may include information on a TEID generated by the target RAG.

According to an embodiment of the disclosure, the third session setup request message may include at least one of information of a tunnel connected between the target RAG and the UPF anchor and information on a TEID generated by the target RAG.

According to an embodiment of the disclosure, the session modification request message may include a message requesting to generate a tunnel connected between the target RAG and the UPF anchor.

FIG. 1C illustrates a communication network including a user plane function (UPF) according to an embodiment of the disclosure.

The communication network is a communication system for forming a 5G network, and may include user plane functions (UPFs) 143-1 to 143-5, an access and mobility management function (AMF) 145-2, a session management function (SMF) 145-1, a policy control function (PCF) 145-3, a user data management (UDM) 145-5, and a home subscriber server (HSS) 145-4.

A UE 190 may perform communication over a radio channel formed with a base station (e.g., an eNB, a gNB), that is, over an access network. In some embodiments, the UE 190 is a device used by a user, and may be configured to provide a user interface (UI). For example, the UE 190 is a terminal equipped in a vehicle for driving. In some other embodiments, the UE 190 may be a device performing machine type communication (MTC) operated without user's involvement, or an autonomous vehicle. Besides an electronic device, the UE may be referred to as a ‘terminal’, a ‘vehicle terminal’, a ‘user equipment (UE)’, a ‘mobile station’, a ‘subscriber station’, a ‘remote terminal’, a ‘wireless terminal’, or a ‘user device’ or other term having the equivalent technical meaning. As the terminal, a customer-premises equipment (CPE) or a dongle-type terminal may be used besides the UE. The CPE is connected to an NG-RAN node like the UE, and may provide the network to other communication equipment (e.g., a laptop).

Referring to FIG. 1C, a UE 190 may be connected to a UPF 170 of the 5G core network through the RAN node 110. The RAN node 110 is a pre-access network and may provide a radio channel for accessing the 5G core network. The RAN node 110 may refer to a base station. A base station is a network infrastructure that provides wireless access to the UE 190. A base station has coverage defined as a predetermined geographical area based on a distance to which a signal may be transmitted. The base station may be referred to as, in addition to the base station, an ‘access point (AP)’, an ‘eNodeB (eNB)’, a ‘gNodeB (Gnb)’, a ‘5th generation node (5G node)’, a ‘5G NodeB (5GNB), a ‘gNodeB (gNB)’, a ‘wireless point’, a ‘transmission/reception point (TRP)’, an ‘access unit’, a ‘distributed unit (DU)’, a ‘radio unit (RU)’, a ‘remote radio head (RRH)’, or other term having the equivalent technical meaning. The configuration of the base station is not limited to examples of base stations performing various embodiments of the disclosure. That is, according to various embodiments, some configurations may be added, deleted, or modified.

A base station according to various embodiments of the disclosure may be implemented to form an access network having a distributed deployment as well as an integrated deployment (e.g., eNB of LTE). As illustrated, the base station is divided into a central unit (CU) and a digital unit (DU), wherein the CU may be implemented to perform upper layer functions (e.g., packet data convergence protocol (PDCP), RRC), and the DU 113 may be implemented to perform lower layer functions (e.g., medium access control (MAC), physical (PHY)).

As such, a base station having a separate deployment may further include a configuration for fronthaul interface communication. According to an embodiment, a base station may, as the DU 113, perform functions for transmitting and receiving signals in a wired communication environment. The DU 113 may include a wired interface for controlling a direct connection between devices through a transmission medium (e.g., copper wire, optical fiber). For example, the DU 113 transmits an electrical signal to another device through a copper wire or perform conversion between an electrical signal and an optical signal. The DU 113 may be connected to the CU of the distributed deployment. However, this description is not construed as excluding a scenario in which the DU 113 is connected to the CU through a wireless network. In addition, the DU may be additionally connected to a radio unit (RU) 111. However, this description is not to be construed as excluding a wireless environment configured only by the CU and DU 113.

Referring to FIG. 1C, the AMF 150 provides a function for access and mobility management in units of UE 190, and may be connected to one AMF 150 for each UE 190 basically. Specifically, the AMF 150 may perform at least one function of signaling between core network nodes for mobility of 3GPP access networks, an interface (N2 interface) between radio access networks (e.g., the 5G RAN), NAS signaling with the UE, identifying the SMF 160, and providing of a session management (SM) message transfer between the UE 117 and the SMF 160. Some or all of the functions of the AMF 150 may be supported within a single instance of one AMF 150.

The SMF 160 provides a session management function, and when the UE 190 has multiple sessions, respective sessions may be managed by different SMFs 160. Specifically, the SMF 160 may perform at least one function of session management (e.g., session establishment, modification, and release including tunnel maintenance between the UPF 170 and the access network node), user plane (UP) function selection and control, traffic steering configuration for routing traffic from the UPF 170 to a proper destination, an end of the SM part of the NAS message, downlink data notification (DDN), and transferring AN-specific SM information to the access network through N2 interface via the initiator (the AMF 150). Some or all functions of the SMF 160 may be supported within a single instance of one SMF 160.

Although not shown in FIG. 1C, an interface between the UPF 170 and other UPFs may be referred to as an N9 interface.

Hereinafter, the disclosure proposes a signal transmission method in a network structure based on UPF function split. In order describe the embodiments of the disclosure, necessary terms are first defined.

Control plane and user plane separation (CUPS): this refers to functional independence of a control plane and a user plane. CUPS enables selection of a user plane more suitable for the RAN according to the intended usage type of the UE, without increasing the number of control planes.

UPF function split: this refers to split of functions supported by UPF. Functions supported by UPF may include IP packet processing and packet classification.

UPF anchor: this refers to a UPF located in a data network (DN) according to UPF function split. According to an embodiment, the UPF anchor may perform routing.

UPF edge: Refers to a UPF located in the RAN according to UPF function split. According to an embodiment, the UPF edge may process IP packets.

Radio access gateway (RAG): this refers to a functional entity in which a UPF edge and a user plane (UP) of a RAN node are combined. According to an embodiment, the RAG may include CU-CP and UPF edge.

Core network based on UP integration: this refers to a core network structure including the RAG and the UPF anchor.

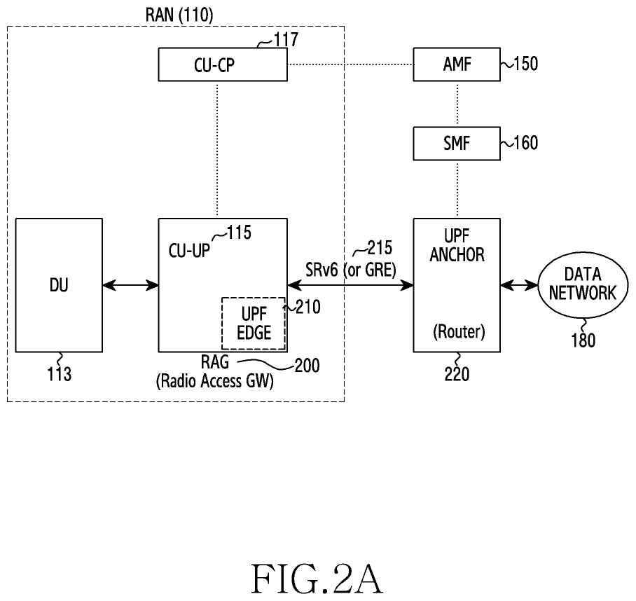

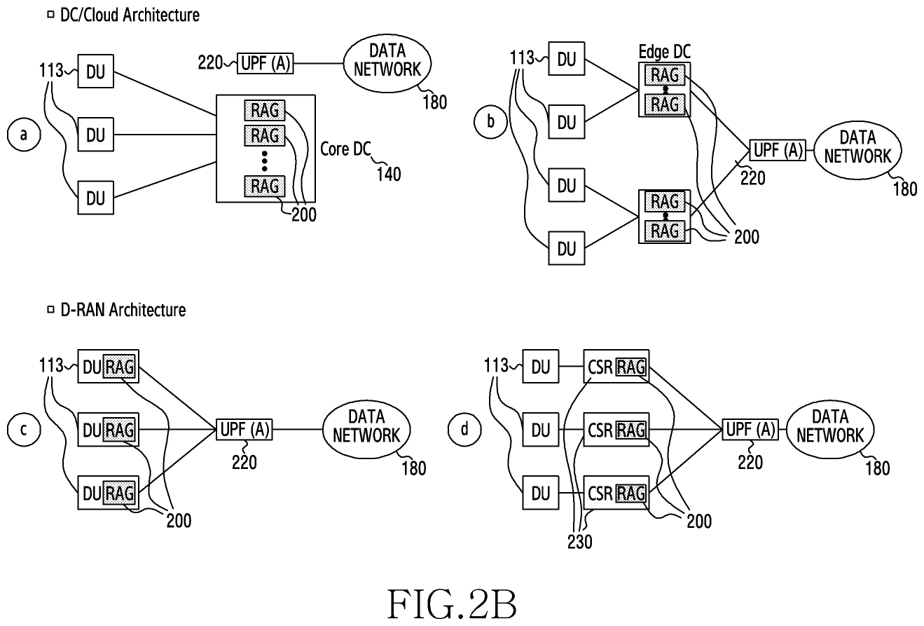

FIG. 2A illustrates a communication network including a separated UPF and a radio access gateway (RAG) according to an embodiment of the disclosure.

In the wireless communication system, as 5G NR was introduced, a user plane 115 and a control plane 117 have been separated and the concept of software-defined networking (SDN) has been introduced. A CU of a RAN node 110 is separated into a central unit (CU)-user plane (UP) 115 and a central unit (CU)-control plane (CP) 117, and these may be connected through an E1 interface. One CU-CP 117 may be connected to a plurality of CU-UPs 115. The CU-UP 115 required for the UE 190 to use a service may be selected and a connection between the CU-UP 115 and a DU 113 may be established. The SDN scheme separates the user plane and control plane of the network to generate a software programmable infrastructure. When using SDN, network management, analysis, or automation functions may be delegated to an SDN controller. The SDN scheme may provide programmability and simplicity to the user plane and flexibility to the control plane in a wireless communication system. The user plane function (i.e., UPF) described above may be complex to implement on entities such as a switch or router due to the need for session and state information. Accordingly, the UPF 170 on the core network may be configured and disposed as a separate entity from the central unit (CU)-user plane (UP) 115.

In a technical aspect, both the CU-UP 115 and the UPF 170 may process packets based on session information of the UE 190. According to various embodiments of the disclosure, an architecture in which an UPF anchor entity 220 is separately disposed and the remaining UPF edges 210 are integrated with the CU-UP 115 and deployed is disclosed. The inclusion of the UPF edge 210 in the CU-UP entity 115 may eliminate a general packet radio service tunneling protocol (GTP) tunnel and a service data association protocol (SDAP) layer between the CU-UP 115 and the UPF. The SDAP layer is a layer that is associated with to the quality of wireless communication (e.g., quality of service (QOS) flow) and is processed by the CU-UP, and the GTP tunnel refers to a tunnel between a base station and a gateway. The GTP tunnel described above refers to a path between CU-UP 115 and UPF 170. When the CU-UP 115 and the UPF 170 are disposed separately, IP packets transmitted between the UE 190 and the data network 180 (i.e., internet) should be subject to GTP tunnel and SDAP layer processing in the UPF 170, and this may result in unnecessary packet delays. According to various embodiments of the disclosure, IP packets may be transmitted based on a unified structure in which the UPF edge 210 is included in the CU-UP 115. A UP integration-based core network may eliminate unnecessary SDAP layer processing and GTP tunnels, resulting in reducing unnecessary packet delays. In addition, each entity may perform efficient IP packet processing and classification through a unified entity.

Referring to FIG. 2A, the UPF may be separated into a UPF anchor 220 and a UPF edge 210 and deployed. The UPF anchor 220 may be implemented on a switch or router platform, as shown in FIG. 2A. The UPF edge 210 may be integrated and deployed with the CU-UP 115 in the RAN node 110. An entity in which the CU-UP 115 and the UPF edge 210 are integrated may be referred to as a radio access gateway (RAG) 200.

The UPF anchor 220 may include a mobility anchor function, such as a home agent for a mobile IP that stores information about a network IP address. The UPF anchor 220 may only require tunnel information for each IP address of the UE, and may not require session information of the terminal (e.g., protocol data network (PDN) connection) requested by the existing UPF 170. Accordingly, the UPF anchor 220 may be implemented as an efficient scale on a switch or router platform. However, the UPF anchor 220 is not limited thereto, and may be implemented as a virtual network function (VNF) or containerized network function (CNF) method for a small data network.

The UPF edge 210 may be an entity that performs other functions than the UPF anchor 220, and may be an endpoint of a PDN connection. The UPF edge 210 may be integrated into the CU-UP 115, and an entity performing this integrated function may be referred to as a RAG 200. By including both the CU-UP 115 and the UPF edge 210, the RAG 200 may eliminate unnecessary function, such as a GTP tunnel between the CU-UP 115 and the UPF 170, an SDAP layer, or a transport QoS between the CU-UP 115 and the UPF 170. However, the effects described above are not necessarily limited to various embodiments of the disclosure.

According to various embodiments of the disclosure, the UPF entity 170 may be separated into the UPF edge 210 and the UPF anchor 220, and scheme for a segment routing over IPv6 dataplane (SRv6) tunneling 215 may be used between the UPF edge 210 and the UPF anchor 220. The SRv6 tunneling 215 is a bearer protocol combining segment routing (SR) with IPv6, and may be implemented by extending a packet header instead of modifying the basic IPv6 packet encapsulation structure. Since the SRv6 tunneling 215 is implemented based on a complete SDN structure, which is suitable for network slicing and service function chaining, and may be used between the RAG 200 and the UPF anchor 220.

According to an embodiment, in a mobile edge computing (MEC) environment, a UPF may be located in each of an edge cloud and a central cloud. The UPF may be distributed to the edge cloud, in addition to the central cloud, and allow services to be provided closer to users. The UPF deployed in the central cloud may be referred to as a UPF Anchor. The UPF anchor may be connected with a DN. According to an embodiment, the UPF anchor may communicate with a central data center. Relatively latency-tolerant services may be provided via the UPF anchor and the central data center. A UPF deployed in an edge cloud may be referred to as a UPF edge. The UPF may be connected to a local data network (DN) as needed. Relatively latency-sensitive services, i.e. low latency services, may be delivered via the UPF edge and the edge data center.

FIG. 2B illustrates various examples of a communication network including a RAG according to an embodiment of the disclosure.

In FIG. 2B, various deployments of the RAG 200 in which the above-described UPF edge 210 and CU-UP 115 are integrated are shown.

Referring to FIG. 2B, a centralized deployment of the RAG 200 including the CU-UP 115 and the UPF edge 210 in the core data center (core DC) 140 or the edge DC may be operated.

According to an embodiment, in the case of ‘a’, a plurality of DUs may be directly connected to the core data center 140. The RAG 200 including the CU-UP 115 and the UPF edge 210 may be deployed in the core data center 140. The UPF anchor 220 may serve as load balancing, and may have the effect of maximizing resource pooling.

According to an embodiment, in the case of ‘b’, a plurality of DUs 113 may be directly connected to data centers, respectively. The RAG 200 including the CU-UP 115 and the UPF edge 210 may be deployed in an edge data center. The UPF anchor 220 may serve as a mobility anchor, and user plane functions may be distributed and processed at the edge data center. The above-described method of deploying and operating the RAG 200 in a data center (e.g., cloud) may significantly reduce the number of commercial off-the-shelf (COTS) servers required compared to deploying the RAG 200 separately. Separately, the above operation method may also significantly reduce the total cost of ownership (TCO) by reducing switches, energy, and other cloud infrastructure resources.

The RAG 200 including the CU-UP 115 and the UPF edge 210 may be disposed in the DU 113 or a cell site router (CSR) 230. Therefore, the deployment of the network may be relatively simplified compared to the case of ‘a’ and ‘b’. According to an embodiment, in the case of ‘c’, the RAG 200 including the CU-UP 115 and the UPF edge 210 may be disposed in each of DUs 113. The UPF anchor 220 may serve as a mobility anchor, and user plane functions may be distributed and processed for each region. According to an embodiment, in the case of ‘d’, the RAG 200 including the CU-UP 115 and the UPF edge 210 may be disposed in each CSR 230. The UPF anchor 220 may serve as a mobility anchor, and user plane functions may be distributed and processed for each region. Since each CSR 230 is associated with a separate DU 113, this arrangement facilitates interworking with other operators' RANS.

Through various deployment structures of the RAG 200 described above, there is no need to build a separate data center for the CU-UP 115 and UPF 170, and separate costs for managing the virtualized cloud infrastructure may be reduced. In addition, by having the UPF anchor entities 220 separately deployed, the networks of many operators can be easily connected to the mobile network.

FIG. 3 illustrates a user plane protocol layer of network entities according to an embodiment of the disclosure.

Specifically, FIG. 3 shows protocol stacks of entities in a UP integration-based core network. The functions of the CU-UP 115 and the UPF edge 210 may be integrated into one network function (NF) (i.e., RAG 200).

Referring to FIG. 3, the RAG 200 may be an end of a protocol data unit (PDU) session initiated by the UE 190. The UPF anchor 220 may be an end of an SRv6 tunnel 215 initiated by the RAG 200.

According to an embodiment, the UE 190 may include an application layer 313, a PDU layer 312, a packet data convergence protocol (PDCP) layer 311, and a 5G-access network (AN) protocol layer 310. According to an embodiment, a DU 113 connected to the UE 190 through a Uu interface may include a 5G-AN protocol layer 324, an L1 layer 320, an L2 layer 321, a user datagram protocol (UDP)/Internet protocol (IP) layer 322, and a GTP-u layer 323. Although not shown in FIG. 3, in the case of the RAN node 110 not including the RAG 200, the base station including the DU 113 and the CU may have the same protocol layer as that of the DU 113 shown in FIG. 3. According to various embodiments of the disclosure, the RAG 200 in which the CU-UP 115 and the UPF edge 210 are integrated may be connected to the DU 113 through an F1 interface. According to an embodiment, the protocol layer of the RAG 200 may include a PDU layer 345 where the PDU session is ended, a PDCP layer 334, a GTP-u layer 333, a UDP/UP layer 332, L2 layers 331 and 347, and L1 layers 330 and 346. In addition, the protocol layer of the RAG 200 may further include an SRv6 layer 349 and an IPV6 layer 348, as the protocol layer is separated from the UPF anchor 220. According to an embodiment, the UPF anchor 220 may be separated from the UPF edge 210 and connected to the RAG 200 through a new interface. The UPF anchor 220 may include an SRv6 layer 353, an IPV6 layer 352, an IP layer 356, and L1 layers 350 and 354, and L2 layers 351 and 355 for SRv6 tunneling 215, which is a pathway to the RAG 200.

The L1 layers 320, 330, and 346 are physical layers and are layers through which data is transmitted. Packets may be transmitted through the L1 layers 330 and 346.

The L2 layers 321, 331, and 347 are data link layers, and are layers in which physical connections between local systems are performed. Communication may be performed in physical nodes through the L2 layers 331 and 347.

The IP layers 322 and 332 are layers that determine a path for transmitting data to a destination. The IP layers 322 and 332 may determine a path of user plane data through a packet switched network.

The UDP layers 322 and 332 are layers that actually transmit and receive data based on path information determined by the IP layer. The UDP layers 322 and 332 are also called transport layers, and may transmit data based on the path determined by the IP layer.

The GTP-u layers 323 and 333 are layers that support user data tunneling through an N3 interface and an N9 interface in a backbone network. The GTP-u layers 323 and 333 may provide encapsulation at the PDU session level.

The PDCP layer 334 may provide ciphering and integrity protection. The PDCP layer 334 may perform IP header compression and decompression, transmission of user data, and maintenance of sequence numbers for radio bearers.

The PDU layers 312 and 345 may be connected using a specific inter-session protocol to provide a data transmission service. The PDU layers 312 and 345 may perform end-to-end control for data transmission between two entities having a session established therebetween.

The application layer 313 is a layer for communicating with users' application program. Services may be provided to programs and users who want to use the network through the application layer 313.

The 5G-AN protocol layers 310 and 324 are protocol layers of a 5G wireless access network and may include a physical (PHY) layer, a medium access control (MAC) layer, a radio link control (RLC) layer, a packet data convergence protocol (PDCP) layer, and a radio resource control (RRC) layer. The 5G-AN protocol layers 310 and 324 may further include, in the case of user plane, a service data adaptation protocol (SDAP) layer.

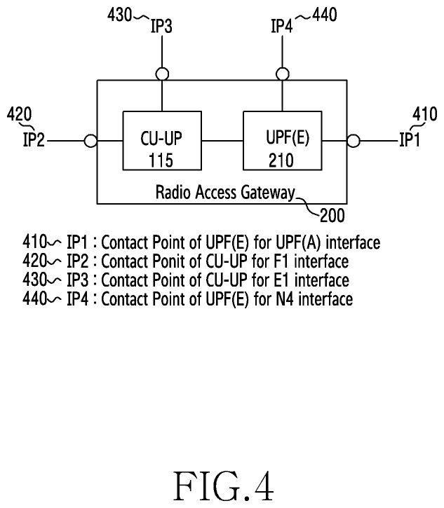

FIG. 4 illustrates an example of a functional structure of a RAG according to an embodiment of the disclosure.

Referring to FIG. 4, the RAG 200 may include a CU-UP 115 and a UPF edge 210. The RAG 200 may manage a plurality of IP addresses. The plurality of IP addresses may include IP addresses such as IP1 410, IP2 420, IP3 430, and IP4 440. The IP1 410 may be an IP address for an N9 interface connecting the UPF edge 210 and the UPF anchor 220. The IP2 420 may be an IP address for an F1 interface connecting the CU-UP 115 and the DU 113. The IP3 430 may be an IP address for an E1 interface connecting the CU-UP 115 and the CU-CP 117. The IP4 440 may be an IP address for an N4 interface connecting the UPF edge 210 and the SMF 160.

According to various embodiments of the disclosure, the RAG 200 in which the CU-UP 115 and the UPF edge 210 are integrated may include interfaces connected to the CU-CP 117 and interfaces connected to the UPF anchor 220. However, the IP1 to IP4 addresses 410 to 440 shown in FIG. 4 are logically defined IP addresses and are not necessarily limited thereto, and one physical interface may be implemented to support two or more IP addresses.

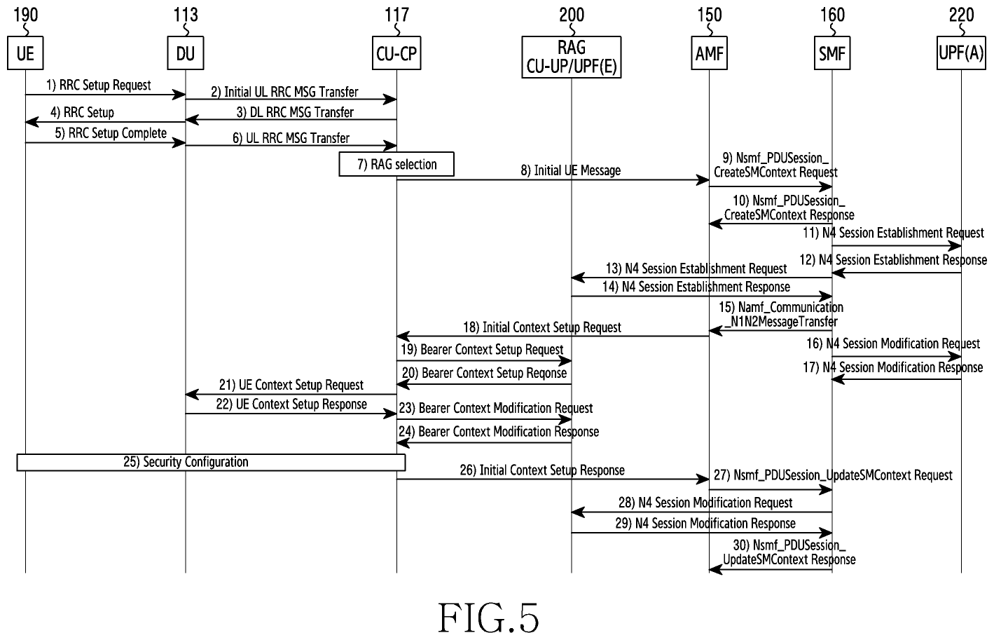

FIG. 5 illustrates a signal flow of network entities for setting up a session according to an embodiment of the disclosure.

Specifically, FIG. 5 illustrates a signal flow between entities for setting up a PDU session in a UP integration-based core network. The flow and interfaces of each signal may be described based on the 5G standard of 3GPP. However, embodiments of the disclosure are not limited to the corresponding standard, and some parameters and usages thereof may be introduced or changed, such that the process of selecting the CU-UP 115 and the UPF edge 210 and the process of using the extended-defined information element (IE) to apply the SRv6 tunnel 215 between the UPF anchor 220 and the UPF edge 210 are based on the IETF specification.

Referring to FIG. 5, according to an embodiment of the disclosure, the RAN node 110 may perform an initial access procedure with the UE 190. Specifically, the UE 190 and the RAN node 110 may complete an initial access procedure through radio resource control (RRC) setup request, RRC setup, and RRC setup complete processes (S1, S2, S3, S4 and S6). As described above, when the initial access procedure between the UE 190 and the RAN node 110 is completed, the UE 190 may perform connection with NFs on each core network.

According to an embodiment, the CU-CP 117 may receive a UL RRC MSG transfer message from the DU 113 (S6). After receiving the UL RRC MSG transfer message, the CU-CP 117 may select the RAG 200 based on the reachability of the UE 190 and the RAN node 110 (S7). The RAG list selection procedure of the CU-CP may be referred to as a candidate RAG selection procedure.

According to an embodiment, the CU-CP may transmit an initial user equipment (UE) message to the AMF 150 (S8). The initial UE message transmitted by the CU-CP to the AMF 150 may include information about the RAG 200 selected by the CU-CP. According to an embodiment, information on the RAG 200 selected by the CU-CP may be defined as RAGF information IE and included in the initial UE message.

TABLE 1

| | | | | |
|---|---|---|---|---|
| IE/Group | Pres- | | | Semantics |
| Name | ence | Range | IE type and reference | description |

| | | | |
|---|---|---|---|
| RAGF ID | M | BIT STRING(SIZE(32, | |
| | | . . . )) | |
| CU-UP- | | | |
| Contact | | | |
| >IP | M | Transport Layer Address | |
| Address | | 3GPP TS38.413 9.3.2.4 | |
| >Port | M | OCTET | UDP or |
| | | STRING(SIZE(2)) | TCP |
| UPF-EDGE- | | | |
| Contact | | | |
| >IP | M | Transport Layer Address | |
| Address | | 3GPP TS38.413 9.3.2.4 | |
| >Port | M | OCTET | UDP or |
| | | STRING(SIZE(2)) | TCP |

Table 1 shows an example of information included in the RAGF information IE. According to an embodiment, the RAGF information IE may include information capable of accessing the selected RAG 200 between the RAN (e.g., CU-CP) node 110 and the NF (e.g., the AMF 150, the SMF 160). Specifically, the RAGF information IE may include at least one of information regarding an identifier (ID) of the selected RAG 200, information regarding IP addresses (e.g., IP2 and IP3) connected to the CU-UP, and information regarding IP addresses (e.g., IP1 and IP4) connected to the UPF edge.

According to an embodiment, the AMF 150 having received the initial UE message including the RAGF information IE may transmit a PDU session setup request message to the SMF 160 (S9). The SMF 160 may select the RAG 200 based on the received PDU session setup request message and RAGF information IE. According to an embodiment, the RAG 200 selected by the SMF 160 may be the same as the set-up PDU session. After selecting the RAG 200, the SMF 160 may transmit a PDU session setup response message to the AMF 150 based on the selected RAG 200 (S10). According to an embodiment, the SMF 160 may select the RAG 200 included in the RAGF information IE. However, selection is not limited thereto, and the SMF 160 may select a RAG other than the corresponding RAG 200 according to another embodiment. The SMF 160 may select another RAG 200 based on traffic load, network slicing selection criteria, policy, and the like. However, even in this case, other selected RAGs 200 should satisfy reachability accessible in the CU-UP and DU. As described above, information on the final RAG 200 selected by the SMF 160 may be included in an initial context setup request message and transmitted to the CU-CP.

According to an embodiment, the SMF 160 that has completed the PDU session setup may initiate a procedure for generating the SRv6 tunnel 215 between the RAG 200 and the UPF anchor 220. Information for configuring the uplink (UL) SRv6 tunnel 215 and the downlink (DL) SRv6 tunnel 215 described below may include an outer header creation IE. According to an embodiment, the outer header creation IE of the disclosure may be an element extended and defined for use as an SRv6 tunneling technology based on an element defined in 3GPP TS 29.244.

TABLE 2

| | Bits | | | | | | | |
|---|---|---|---|---|---|---|---|---|
| Octets | 8 | 7 | 6 | 5 | 4 | 3 | 2 | 1 |

| | |
|---|---|
| 1 to 2 | Type = 84 (decimal) |
| 3 to 4 | Length = n |
| 5 to 6 | Outer Header Creation Description |
| m to (m + 3) | TEID |
| p to (p + 3) | IPv4 Address |
| q to (q + 15) | IPv6 Address |
| r to (r + 1) | Port Number |
| t to (t + 2) | C-TAG |
| u to (u + 2) | S-TAG |
| v to (v + 32 w) | SID(128 bits) × w |
| s to (n + 4) | These octet(s) is/are present only if |
| | explicitly specified |

Table 2 shows an example of an outer header creation IE according to an embodiment of the disclosure. The outer header creation IE may include information about a segment ID (SID). The SID may be an identifier for identifying a SRv6 node required when data of the UE 190 is transmitted via the UPF edge 210 and the UPF anchor 220. For example, the SID is an identifier of identifying a path for connection to the UPF anchor 220. Referring to Table 2, the SID may have a length of 128 bits, and the number may be extended up to w. According to an embodiment, in the case of a UPF in which the UPF edge 210 and the UPF anchor 220 are not separated, the SID may not be required. In this case, since the address of the final UPF is identified by the IPv6 address identifier, there is no need to identify the SID. According to various embodiments of the disclosure, on a core network having a RAG 200 structure, the UPF edge 210 and the UPF anchor 220 may be separated and connected using the SRv6 tunnel 215, the SID may be needed.

According to an embodiment, the outer header creation IE may be transmitted according to at least one of a forwarding action rule (FAR) or a packet detection rule (PDR). The outer header creation description of Table 2 may include identification information corresponding to each octet or bit. According to an embodiment, the outer header creation description of the disclosure may be an element extended and defined for use with SRv6 tunneling technology based on elements defined in 3GPP TS 29.244.

TABLE 3

| Octet/Bit | Outer Header to be created in the outgoing packet |
|---|---|
| 5/1 | GTP-U/UDP/IPv4 |
| 5/2 | GTP-U/UDP/IPv6 |
| 5/3 | UDP/IPv4 |
| 5/4 | UDP/IPv6 |
| 5/5 | IPv4 |
| 5/6 | IPv6 |
| 5/7 | C-TAG |
| 5/8 | S-TAG |
| 6/1 | N19 Indication |
| 6/2 | N6 Indication |
| 6/3 | Low Layer SSM and C-TEID |
| 6/4 | Segment Routing |

Table 3 shows information identified corresponding to each octet or bit of the outer header description of Table 2 according to an embodiment of the disclosure. Referring to Table 3, bit #4 of octet #6 may indicate identification information defined to establish the SRv6 tunnel 215. For example, when the information of the outer header description includes identification information for segment routing (SR), the FAR transfers the corresponding packet through the identified SRv6 tunnel 215. According to an embodiment, in the case of a UPF in which the UPF edge 210 and the UPF anchor 220 are not separated, the SR may not be required. According to various embodiments of the disclosure, on a core network having a RAG 200 structure, since the UPF edge 210 and the UPF anchor 220 may be separated and connected using the SRv6 tunnel 215, the definition and identification for the SR may be required.

TABLE 4

| | Bits | | | | | | | |
|---|---|---|---|---|---|---|---|---|
| Octets | 8 | 7 | 6 | 5 | 4 | 3 | 2 | 1 |

| 1 to 2 | Type = 21 (decimal) | | | | | |
|---|---|---|---|---|---|---|
| 3 to 4 | Length = n | | | | | |
| 5 | Spare | SR | CHID | CH | V6 | V4 |

| | |
|---|---|
| 6 to 9 | TEID |
| m to (m + 3) | IPv4 address |
| p to (p + 15) | IPv6 address |
| q | CHOOSE ID |
| k to (n + 4) | These octet(s) is/are present only if explicitly specified |

Table 4 shows specific examples of outer header creation IEs according to an embodiment of the disclosure. Referring to fully qualified TEID (F-TEID) IE of 3GPP TS29.244, the SMF 160 may indicate IPv4 or IPv6 to control the UPF by using a bit of octet #5. Bit #5 to #8 of octet #5 of the F-TEID IE of 3GPP TS 29.244 are spare bits and may be extra bits for including other information. According to various embodiments of the disclosure, bit #5 of octet #5 of the F-TEID IE may be a bit indicating whether it is SR. For example, when bit #5 of octet #5 of the F-TEID IE is configured as 1, the TEID and IP address may be identified based on the SRv6 protocol.

According to an embodiment, the SMF 160 that has transmitted the PDU session generation response message to the AMF 150 may transmit an N4 session setup request message to the UPF anchor 220 (S11). N4 interface through which the SMF 160 requests the UPF anchor 220 to establish the N4 session may refer to an interface between the SMF 160 and the UPF anchor 220 of the disclosure. According to an embodiment, the N4 session setup request message may include an IP address allocation request message and an end configuration request message for the UL SRv6 tunnel 215. Upon receiving the N4 session setup request message, the UPF anchor 220 may transmit an N4 session setup response message to the SMF 160 (S12). The N4 session setup response message transmitted by the UPF anchor 220 may include IP address of the UE 190 and information of the UL SRv6 tunnel 215.

According to an embodiment, the SMF 160 may transmit an N4 session setup request message to the RAG 200 based on the N4 session setup response message received from the UPF anchor 220 (S13). The N4 interface through which the SMF 160 requests the RAG 200 to establish the N4 session may refer to an interface between the SMF 160 and the UPF edge included in the RAG 200 of the disclosure. That is, the N4 interface may be connected using the IP4 address described in FIG. 4. According to an embodiment, the N4 session setup request message transmitted by the SMF 160 to the RAG 200 may include information of the UL SRv6 tunnel 215 and a request message for an end of the DL SRv6 tunnel 215.

According to an embodiment, the RAG 200 may generate information of the DL SRv6 tunnel 215 and context information for the corresponding UE 190 based on the N4 session setup request message received from the SMF 160. The context information of the UE 190 is an information block of a base station associated with one active UE 190 and may include status information, security information, capability information, and the like of the UE 190. According to an embodiment, the RAG 200 may generate a tunnel endpoint identifier (TEID) used to distinguish traffic between UPF edges of the corresponding UE 190. The TEID generated by the RAG 200 may include at least one of a downlink (DL) TEID or an uplink (UL) TEID. The TEID may be used as tunnel identification information between each UPF edge and the UPF anchor 220 based on traffic of each UPF edge connected to the corresponding UE 190.

According to an embodiment, the RAG 200 may transmit an N4 session setup response message to the SMF 160 (S14). The N4 session setup response message transmitted from the RAG 200 to the SMF 160 may include at least one of the context for the corresponding UE 190, information of the DL SRv6 tunnel 215, or information of the generated TEID.

According to an embodiment, the SMF 160 may transmit an N4 session modification request message to the UPF anchor 220 based on the N4 session setup response message received from the RAG 200 (S16). According to an embodiment, the SMF 160 may complete establishment of the DL SRv6 tunnel 215 by receiving an N4 session modification response message generated based on the N4 session modification request message from the UPF anchor 220 (S17).

According to an embodiment, the SMF 160 having received the N4 session modification response message may transmit an initial context setup request message to the CU-CP 117 through the AMF 150 based on the received message (S15, S18). The CU-CP 117 may receive an initial context setup request message from the AMF 150. The CU-CP 117 may transmit a bearer context setup request message to the selected RAG 200 (S19). According to an embodiment, the bearer context setup request message transmitted by the CU-CP 117 may include an internal tunnel establishment request message between the CU-UP and the UPF edge and a tunnel generation request message of the F1 interface. According to an embodiment, the bearer context setup request message transmitted from the CU-CP 117 may include information about the DL TEID transmitted from the SMF. The RAG 200 may distinguish DL traffic of the UE 190 by using the received information on the DL TEID.

According to an embodiment, the RAG 200 may generate a UL TEID for distinguishing UL traffic of the UE 190. The RAG 200 may transmit a bearer context setup response message to the CU-CP (S20). According to an embodiment, a bearer context setup response message transmitted from the RAG 200 to the CU-CP may include information on the UL-TEID.

According to an embodiment, the CU-CP 117 may transmit a UE context setup request message to the DU 113 (S21). According to an embodiment, the DU 113 may transmit a UE context setup response message to the CU-CP 117 (S22). According to an embodiment, the CU-CP 117 may transmit a bearer context modification request message to the RAG 200 based on the UE context setup response message received from the DU (S23). According to an embodiment, the RAG 200 may transmit a bearer context modification response message to the CU-CP 117 (S24).

According to an embodiment, the CU-CP 117 may transmit an initial context setup response message to the AMF 150 (S26). According to an embodiment, the AMF 150 may transmit a PDU session update context request message to the SMF 160 based on the initial context setup response message received from the CU-CP 117 (S27). According to an embodiment, the SMF 160 having received the PDU session update context request message may transmit an N4 session modification request message to the RAG 200 (S28). According to an embodiment, the initial context setup response message transmitted by the CU-CP 117, the PDU session update context request message transmitted by the AMF 150, and the N4 session modification request message transmitted by the SMF 160 may include information about the UL TEID generated by the RAG 200. As described above, the UPF edge included in the may receive information about the TEID based on message transmission or reception between one or more entities among the RAG 200, CU-CP 117, AMF 150, or SMF 160. However, the transfer of the TEID described above is based on 3GPP specifications where the CU-UP 115 and the UPF edge 210 are treated as independent separate entities, and embodiments of the disclosure are not limited to FIG. 5. According to another embodiment, unlike the signaling described above, information about TEID within the RAG 200 may be transferred between the CU-UP 115 and the UPF edge 210.

According to an embodiment, the RAG 200 may transmit an N4 session modification response message to the SMF 160 (S29). According to an embodiment, the SMF 160 may transmit a PDU session update context response message to the AMF 150.

With reference to FIG. 5, a procedure for simplifying the signaling of the initial access procedure in the core network, through an entity of the RAG 200 in which a UPF edge and a CU-UP are integrated, has been described. The IEs associated with the RAG 200 described above may be used not only for the above signaling, but also for the E1, N2 and N4 interfaces defined in 3GPP.

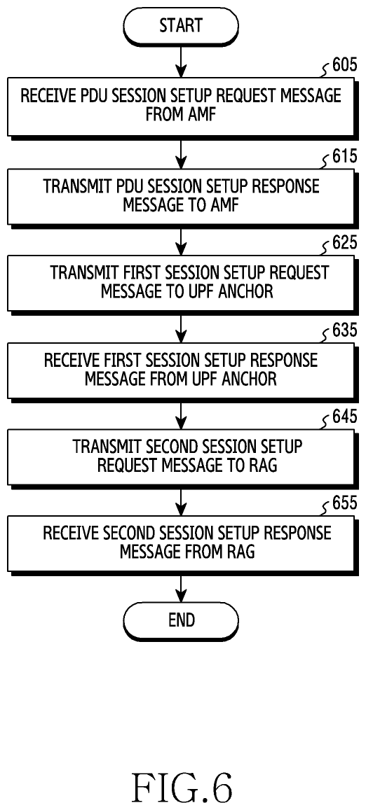

FIG. 6 illustrates an operation flow for session setup of a session management function (SMF) device according to an embodiment of the disclosure.

As described above, the SMF 160 may provide a session management function, and when the UE 190 has multiple sessions, the respective sessions may be managed by different SMFs. Specifically, the SMF 160 may perform at least one function of session management (e.g., session establishment, modification, and release including tunnel maintenance between the UPF 170 and the access network node), UP function selection and control, traffic steering configuration for routing traffic from the UPF 170 to a proper destination, an end of the SM part of the NAS message, downlink data notification, and transferring AN-specific SM information to the access network through N2 interface via the initiator (the AMF 150). Some or all functions of the SMF 160 may be supported within a single instance of the SMF 160.

Referring to FIG. 6, in operation 605, the SMF 160 may receive a PDU session setup request message from the AMF 150. According to an embodiment, the PDU session setup request message transmitted by the AMF 150 may include the RAGF information IE. According to an embodiment, the RAGF information IE may be information about a RAG 200 selected by the CU-CP, which has received a UL RRC MSG transfer message, based on the reachability of the RAN node 110 and the corresponding terminal (i.e., UE 190). According to an embodiment, the RAGF information IE may include information capable of accessing the selected RAG 200 between the RAN (e.g., CU-CP) node 110 and the NF (e.g., the AMF 150, the SMF 160). Specifically, the RAGF information IE may include at least one of information regarding an identifier of the selected RAG 200, information regarding IP addresses (e.g., IP2 and IP3) connected to the CU-UP, and information regarding IP addresses (e.g., IP1 and IP4) connected to the UPF edge.

In operation 615, the SMF 160 may transmit a PDU session setup response message to the AMF 150. According to an embodiment, the SMF 160 may select the RAG 200 based on the received PDU session setup request message and the RAGF information IE. According to an embodiment, the RAG 200 selected by the SMF 160 may be the same as the set-up PDU session. After selecting the RAG 200, the SMF 160 may transmit a PDU session setup response message to the AMF 150 based on the selected RAG 200. The SMF 160 may select the RAG 200 included in the RAGF information IE, but is not limited thereto, and the SMF 160 may select another RAG 200 based on traffic load, network slicing selection criteria, policy, and the like. However, even in this case, the selected other RAG 200 should satisfy reachability accessible in the CU-UP and DU. As described above, information on the final RAG 200 selected by the SMF 160 may be included in an initial context setup request message and transmitted to the CU-CP.

In operation 625, the SMF 160 may transmit a first session setup request message to the UPF anchor 220. According to an embodiment, the first session setup request message may be an N4 session setup request message transmitted by the SMF 160 to the UPF anchor 220. According to an embodiment, the SMF 160 that has completed the PDU session setup may initiate a procedure for generating the SRv6 tunnel 215 between the RAG 200 and the UPF anchor 220. Information for configuring the uplink (UL) SRv6 tunnel 215 and the downlink (DL) SRv6 tunnel 215 described below may include an outer header creation IE. According to an embodiment, the outer header creation IE of the disclosure may be an element extended and defined for use as an SRv6 tunneling technology based on an element defined in 3GPP TS 29.244. According to an embodiment, a detailed description of the outer header creation IE of the disclosure is described through Tables 2 to 4. According to an embodiment, the SMF 160 that has transmitted the PDU session generation response message to the AMF 150 may transmit a first session setup request message to the UPF anchor 220. The N4 interface through which the SMF 160 requests the UPF anchor 220 to establish the first session may refer to an interface between the SMF 160 and the UPF anchor 220 of the disclosure. According to an embodiment, the first session setup request message may include an IP address allocation request message and an end configuration request message for the UL SRv6 tunnel 215.

In operation 635, the SMF 160 may receive a first session setup response message from the UPF anchor 220. According to an embodiment, the SMF 160 may receive a first session setup response message from the UPF anchor 220 that has received the first session setup request message. The first session setup response message transmitted by the UPF anchor 220 may include IP address of the UE 190 and information of the UL SRv6 tunnel 215.

In operation 645, the SMF 160 may transmit a second session setup request message to the RAG 200. According to an embodiment, the second session setup request message may be an N4 session setup request message transmitted by the SMF 160 to the RAG 200. According to an embodiment, the SMF 160 may transmit a second session setup request message to the RAG 200 based on the first session setup response message received from the UPF anchor 220. The N4 interface through which the SMF 160 requests the RAG 200 to establish the second session may refer to an interface between the SMF 160 and the UPF edge included in the RAG 200 of the disclosure. That is, the N4 interface may be connected using the IP4 address described in FIG. 4. According to an embodiment, the second session setup request message transmitted by the SMF 160 to the RAG 200 may include information of the UL SRv6 tunnel 215 and an end request message for the DL SRv6 tunnel 215.

In operation 655, the SMF 160 may receive a second session setup response message from the RAG 200. According to an embodiment, the RAG 200 may generate context information for the UE 190 and information of the DL SRv6 tunnel 215 based on the second session setup request message received from the SMF 160. The context information of the UE 190 is an information block of a base station associated with one active UE 190 and may include status information, security information, capability information, and the like of the UE 190. According to an embodiment, the RAG 200 may generate a tunnel endpoint identifier (TEID) used to distinguish traffic between UPF edges of the corresponding UE 190. The TEID may be used as tunnel identification information between each UPF edge and the UPF anchor 220 based on traffic of each UPF edge connected to the corresponding UE 190. According to an embodiment, the SMF 160 may receive the second session setup response message from the RAG 200. The second session setup response message received by the SMF 160 from the RAG 200 may include at least one of context for the corresponding UE 190, information of the DL SRv6 tunnel 215, or information regarding the generated TEID, which are described above.

Although not shown in FIG. 6, according to an embodiment, the SMF 160 may transmit an N4 session modification request message to the UPF anchor 220 based on the N4 session setup response message received from the RAG 200. According to an embodiment, the SMF 160 may complete establishment of the DL SRv6 tunnel 215 by receiving the N4 session modification response message, which is generated based on the N4 session modification request message, from the UPF anchor 220. According to an embodiment, upon receiving the N4 session modification response message, the SMF 160 may transmit an initial context setup request message to the CU-UP based on the received message.

With reference to FIG. 6, a procedure for simplifying signaling of an initial access procedure in a core network, through an entity of the RAG 200 in which a UPF edge and a CU-UP are integrated, has been described. The IEs associated with the RAG 200 described above may be used not only for the above signaling, but also for the E1, N2 and N4 interfaces defined in 3GPP.

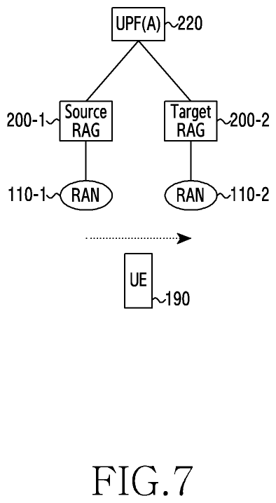

FIG. 7 illustrates handover related to mobility support on a core network according to an embodiment of the disclosure.

Handover may refer to a function in which, when the UE 190 moves from a service space of a base station, to which the UE 190 is connected, to a service space of another base station, the UE 190 is connected to the service space of the other base station. According to various embodiments of the disclosure, a network function (NF) in which a CU-UP and a UPF edge are integrated may be referred to as a RAG 200. According to an embodiment, in the disclosure, in which the UP is reconstructed by integrating the CU-UP and the UPF edge into one NF, inter-RAG handover may occur.

Referring to FIG. 7, when the UE 190 moves from a space served by a first RAN node 110-1 to a space served by a second RAN node 110-2, a mobility support plan may be required. According to an embodiment, a RAG which is an NF obtained by integrating a UPF edge and a CU-UP associated with the first RAN node 110-1 may be referred to as a source RAG 200-1. According to an embodiment, a RAG which is an NF obtained by integrating a UPF edge and a CU-UP associated with the second RAN node 110-2 may be referred to as a target RAG 200-2. According to an embodiment, the UPF anchor 220 may be pre-determined during the PDU session setup process between the UE 190 and the first RAN node 110-1 before the handover procedure. According to an embodiment of the disclosure, handover procedure of the UE 190 is initiated between a plurality of RAGs (e.g., the source RAG 200-1 and the target RAG 200-2) connected to the predetermined UPF anchor 220.

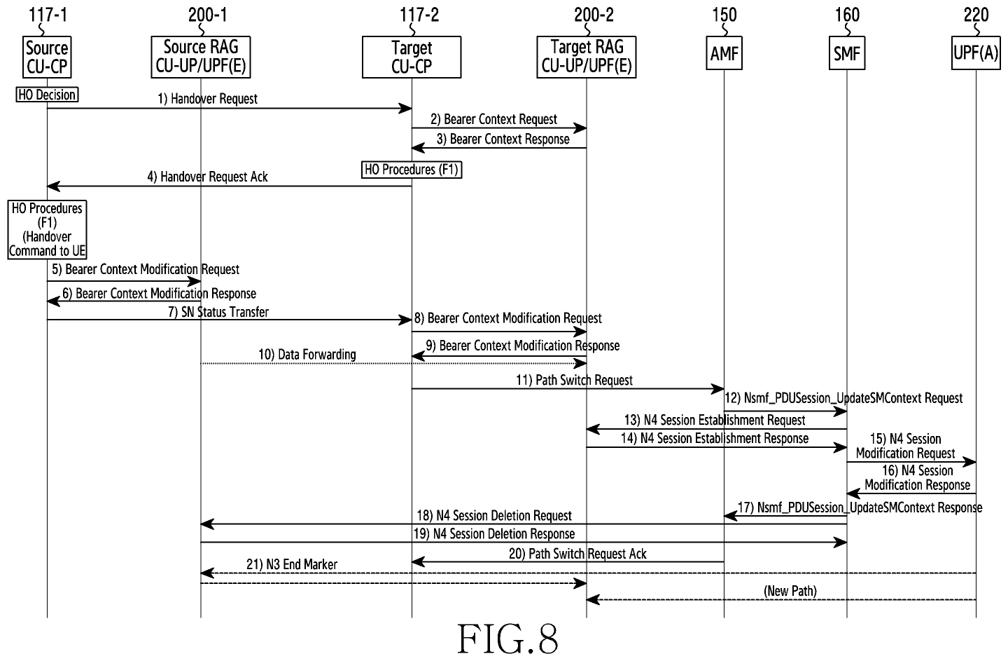

FIG. 8 illustrates a signal flow of network entities for setting up a session in a handover process of a UE according to an embodiment of the disclosure.

Specifically, FIG. 8 illustrates a signal flow for handover from a source CU-CP 117-1 and a source RAG 200-1 to a target CU-CP 117-2 and a target RAG 200-2. Each signal flow and interface shown in FIG. 8 may be described based on the 3GPP 5G standard. However, it is not necessarily limited thereto, and some parameters and usage of parameters may be newly established or changed in order to use RAG in which the CU-UP and the UPF edge are integrated.

Referring to FIG. 8, according to an embodiment of the disclosure, the source CU-CP 117-1 and the target CU-CP 117-2 may perform a handover procedure based on the mobility of the UE 190. Specifically, when a determination to handover is made, the source CU-CP 117-1 may transmit a handover request message to the target CU-CP 117-2 (S1).

According to an embodiment, the target CU-CP 117-2 having received the handover request message from the source CU-CP 117-1 may transmit a bearer context request message to the target RAG 200-2 (S2). The bearer context request message transmitted by the target CU-CP to the target RAG 200-2 may include a user data path generation request message for the handover UE 190. The target RAG 200-2 may transmit a bearer context response message including a result of the user data path generation request to the target CU-CP 117-2 (S3). According to an embodiment, the bearer context response message may include general packet radio service tunneling protocol (GTP) tunnel information as PDU session information for the UPF edge included in the target RAG 200-2. According to an embodiment, the GTP tunnel transport layer address of the PDU session information included in the bearer context response message may include an IP address for an N4 interface connecting the UPF edge included in the target RAG 200-2 and the SMF 160. According to an embodiment, the IP4 address shown in FIG. 4 may be included in the GTP tunnel transport layer address of the PDU session information included in the bearer context response message. According to an embodiment, the bearer context response message may further include a TEID generated, by the target RAG 200-2, for the GTP tunnel of the PDU session.

According to an embodiment, the target CU-CP 117-2 having received the bearer context response message may perform a handover procedure for F1 interface. The target CU-CP 117-2 may transmit a handover request acknowledgment (ACK) message to the source CU-CP 117-1 (S4). According to an embodiment, the source CU-CP 117-1 having received the handover request ACK message may perform handover control for the UE 190. According to an embodiment, the transmission and reception of the bearer context change request message and the bearer context change response message between the source CU-CP 117-1 and the source RAG 200-1 and between the target CU-CP 117-2 and the target RAG 200-2 may be performed (S5, S6, S8, S9). Procedures for transmitting and receiving the bearer context modification request message and the bearer context modification response message may be performed according to the 3GPP 5G standard.

According to an embodiment, the target CU-CP 117-2 may transmit a path switch request message to the AMF 150 (S11). The AMF 150 may transmit a PDU session update request message to the SMF 160 based on the received path switch request message (S12). According to an embodiment, the PDU session update request message may include GTP tunnel information as PDU session information for the UPF edge included in the target RAG 200-2. According to an embodiment, the GTP tunnel transport layer address of the PDU session information included in the PDU session update request message may include an IP address for an N4 interface connecting the UPF edge included in the target RAG 200-2 and the SMF 160. According to an embodiment, the IP4 address shown in FIG. 4 may be included in the GTP tunnel transport layer address of the PDU session information included in the PDU session update request message. According to an embodiment, the PDU session update request message may further include a TEID generated, by the target RAG 200-2, for the GTP tunnel of the PDU session.

According to an embodiment, the SMF 160 may transmit an N4 session setup request message to the target RAG 200-2 (S13). According to an embodiment, the N4 session setup request message transmitted by the SMF 160 to the target RAG 200-2 may include at least one of IP4 address information, TEID, and information regarding an end of the SRv6 tunnel 215. According to an embodiment, the N4 session setup request message transmitted by the SMF 160 to the target RAG 200-2 may further include various pieces of policy information required for the UPF edge to process user plane functions for data of the corresponding UE 190. According to an embodiment, the SMF 160 may establish an association with the CU-UP internally by transmitting the N4 session setup request message to the target RAG 200-2. According to an embodiment, the SMF 160 may request the target RAG 200-2 to generate a new link with the UPF anchor 220 by transmitting the N4 session setup request message. According to an embodiment, the SMF 160 may request the target RAG 200-2 to generate a PDR and a FAR by transmitting the N4 session setup request message.

According to an embodiment, the target RAG 200-2 may establish a tunnel in the UL direction. According to an embodiment, the target RAG 200-2 may configure UL-direction packet filtering and tunnel based on the N4 session setup request message received from the SMF 160. The packet filtering configured by the target RAG 200-2 may be configured based on the TEID generated by the target RAG 200-2. The target RAG 200-2 may establish a tunnel capable of delivering data to the UPF anchor 220 through the UL SRv6 tunnel 215. According to an embodiment, the N4 session setup request message received from the SMF 160 by the target RAG 200-2 may include tunnel endpoint information, which may be delivered to the UPF anchor 220, in the form of the outer header creation IE format included in the FAR IE. The FAR and outer header creation IE described above may be elements extended and defined based on elements defined in 3GPP TS 29.244, as described through Tables 2 to 4.

According to an embodiment, the target RAG 200-2 may establish a tunnel in the DL direction. According to an embodiment, the PDU session update message received by the SMF 160 from the AMF 150 may include information about the PDR. According to an embodiment, the SMF 160 may configure packet filtering in the DL direction based on the PDR information of the PDU session update message received from the AMF 150. According to an embodiment, the target RAG 200-2 may perform packet filtering based on the FAR included in the N4 session setup request message received from the SMF 160. According to an embodiment, the target RAG 200-2 may generate a TEID to be used when interworking with the CU-UP. According to an embodiment, the target RAG 200-2 may transmit an N4 session setup response message including the generated TEID to the SMF 160 (S14). The N4 session setup response message transmitted by the target RAG 200-2 to the SMF 160 may include the TEID generated by the target RAG 200-2, in the format of an F-TEID IE included in the PDR IE. The PDR and F-TEID IE described above may be elements extended and defined based on elements defined in 3GPP TS 29.244, as described through Tables 2 to 4.

According to an embodiment, the SMF 160 may transmit an N4 session modification request message to the UPF anchor 220 (S15). According to an embodiment, the N4 session modification request message transmitted by the SMF 160 to the UPF anchor 220 may include a message requesting to generate an SRv6 tunnel 215 connected to the target RAG 200-2. According to an embodiment, the UPF anchor 220 may switch the DL-direction SRv6 tunnel 215 based on a message requesting to generate the SRv6 tunnel 215 and information of the SRv6 tunnel 215, which are received from the SMF 160. The N4 session modification request message transmitted by the SMF 160 to the UPF anchor 220 may include information of the SRv6 tunnel 215, in the format of an outer header creation IE included in the FAR IE. The FAR and outer header creation IE described above may be elements extended and defined based on elements defined in 3GPP TS 29.244, as described through Tables 2 to 4.

According to an embodiment, the SMF 160 may receive an N4 session modification response message from the UPF anchor 220 (S16). According to an embodiment, the N4 session modification response message received by the SMF 160 from the UPF anchor 220 may include information regarding modification of the DL-direction SRv6 tunnel 215 of the UPF anchor 220.

According to an embodiment, the SMF 160 may transmit a PDU session update response message to the AMF 150 based on information regarding modification of the DL-direction SRv6 tunnel 215 of the UPF anchor 220 (S17). According to an embodiment, the establishment of the SRv6 tunnel 215 between the target RAG 200-2 and the UPF anchor 220 may be considered complete when the SMF 160 transmits the PDU session update response message to the AMF 150.

According to an embodiment, the SMF 160 may transmit an N4 session deletion request message to the source RAG 200-1 (S18). The SMF 160 may request release of a connection previously established between the source RAG 200-1 and the UPF anchor 220 by transmitting the N4 session deletion request message to the source RAG 200-1. According to an embodiment, the SMF 160 may receive an N4 session deletion response message from the source RAG 200-1 (S19). As the SMF 160 receives the N4 session deletion response message from the source RAG 200-1, the release of the connection between the source RAG 200-1 and the UPF anchor 220 may be considered complete.

According to an embodiment, the AMF 150 may transmit a path switch request ACK message to the target CU-CP 117-2 (S20). According to an embodiment, the UPF anchor 220 may transmit an N3 end marker message to the source RAG 200-1. According to an embodiment, the source RAG 200-1 may transmit an N3 end marker message to the target RAG 200-2 (S21). The N3 end marker may denote the end of a payload stream in a tunnel of an N3 interface.

Through the above-described process, the UPF anchor 220 may complete the establishment of the target RAG 200-2 path newly established by the handover procedure of the UE 190. With reference to FIG. 8, a procedure for simplifying signaling of an initial access procedure in a core network, through an entity of the RAG 200 in which a UPF edge and a CU-UP are integrated, has been described. The IEs associated with the RAG 200 described above may be used not only for the signaling, but also for E1, N2, and N4 interfaces defined in 3GPP.

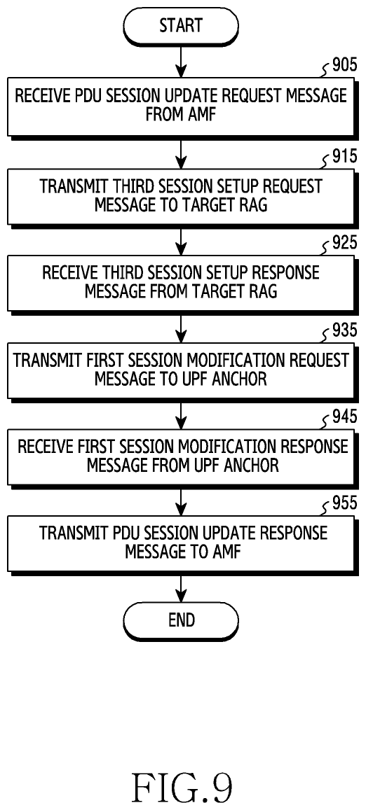

FIG. 9 illustrates an operation flow for session setup of an SMF device in a handover process of a UE according to an embodiment of the disclosure.

As described above, the SMF 160 provides a session management function, and when the UE 190 has multiple sessions, each session may be managed by a different SMF 160. Specifically, the SMF 160 may perform at least one function of session management (e.g., session establishment, modification, and release including tunnel maintenance between the UPF 170 and the access network node), UP function selection and control, traffic steering configuration for routing traffic from the UPF 170 to a proper destination, an end of the SM part of the NAS message, downlink data notification, and transferring AN-specific SM information to the access network through N2 interface via the initiator (the AMF 150). Some or all functions of the SMF 160 may be supported within a single instance of one SMF 160.

Referring to FIG. 9, in operation 905, the SMF 160 may receive a PDU session update request message from the AMF 150. According to an embodiment, the PDU session update request message may include GTP tunnel information as PDU session information for the UPF edge included in the target RAG 200-2. According to an embodiment, the GTP tunnel transport layer address of the PDU session information included in the PDU session update request message may include an IP address for an N4 interface connecting the UPF edge included in the target RAG 200-2 and the SMF 160. According to an embodiment, the IP4 address shown in FIG. 4 may be included in the GTP tunnel transport layer address of the PDU session information included in the PDU session update request message. According to an embodiment, the PDU session update request message may further include a TEID generated, by the target RAG 200-2, for the GTP tunnel of the PDU session.

In operation 915, the SMF 160 may transmit a third session setup request message to the target RAG 200-2. According to an embodiment, the third session setup request message may be an N4 session setup request message transmitted by the SMF 160 to the target RAG 200-2. According to an embodiment, the third session setup request message transmitted by the SMF 160 to the target RAG 200-2 may include at least one of IP4 address information, TEID, and information regarding an end of the SRv6 tunnel 215. According to an embodiment, a third session setup request message transmitted by the SMF 160 to the target RAG 200-2 may further include various types of policy information required for the UPF edge to process the user plane function for the data of the corresponding UE 190. According to an embodiment, the SMF 160 may establish an association with the CU-UP internally by transmitting a third session setup request message to the target RAG 200-2. According to an embodiment, the SMF 160 may request the target RAG 200-2 to generate a new link with the UPF anchor 220 by transmitting a third session setup request message. According to an embodiment, the SMF 160 may request the target RAG 200-2 to generate a PDR and FAR by transmitting a third session setup request message. According to an embodiment, the third session setup request message transmitted by the SMF 160 to the target RAT may include tunnel endpoint information, which may be delivered to the UPF anchor 220, in the form of an outer header creation IE format included in the FAR IE. The FAR and outer header creation IE described above may be elements extended and defined based on elements defined in 3GPP TS 29.244, as described through Tables 2 to 4. According to an embodiment, the SMF 160 may configure packet filtering in the DL direction based on the PDR information of the PDU session update message received from the AMF 150.

In operation 925, the SMF 160 may receive a third session setup response message from the target RAG 200-2. According to an embodiment, the third session setup response message may be an N4 session setup response message received by the SMF 160 from the target RAG 200-2. According to an embodiment, the third session setup response message received by the SMF 160 from the target RAG 200-2 may include a TEID generated by the target RAG 200-2. According to an embodiment, the third session setup response message received by the SMF 160 from the target RAG 200-2 may include the TEID, which is generated by the target RAG 200-2, in the format of the F-TEID IE included in the PDR IE. The PDR and F-TEID IE described above may be elements extended and defined based on elements defined in 3GPP TS 29.244, as described through Tables 2 to 4.

In operation 935, the SMF 160 may transmit a first session modification request message to the UPF anchor 220. According to an embodiment, the first session modification request message may be an N4 session modification request message transmitted by the SMF 160 to the UPF anchor 220. According to an embodiment, the first session modification request message transmitted by the SMF 160 to the UPF anchor 220 may include a message requesting generation of a SRv6 tunnel 215 connected to the target RAG 200-2. According to an embodiment, the UPF anchor 220 may modify the DL-direction SRv6 tunnel 215 based on the message requesting generation of the SRv6 tunnel 215 and information of the SRv6 tunnel 215, which are received from the SMF 160. The first session modification request message transmitted by the SMF 160 to the UPF anchor 220 may include information of the SRv6 tunnel 215, in the format of an outer header creation IE included in the FAR IE. The FAR and outer header creation IE described above may be elements extended and defined based on elements defined in 3GPP TS 29.244, as described through Tables 2 to 4.

In operation 945, the SMF 160 may receive a first session modification response message from UPF anchor 220. According to an embodiment, the first session modification response message may be an N4 session modification response message received by the SMF 160 from the UPF anchor 220. According to an embodiment, the first session modification response message received by the SMF 160 from the UPF anchor 220 may include information regarding modification of the DL-direction SRv6 tunnel 215 of the UPF anchor 220.

In operation 955, the SMF 160 may transmit a PDU session update response message to the AMF 150. According to an embodiment, the SMF 160 may transmit a PDU session update response message to the AMF 150 based on information regarding modification of the DL-direction SRv6 tunnel 215 of the UPF anchor 220. According to an embodiment, the establishment of the SRv6 tunnel 215 between the target RAG 200-2 and the UPF anchor 220 may be considered complete when the SMF 160 transmits a PDU session update response message to the AMF 150.

Although not shown in FIG. 9, according to an embodiment, the SMF 160 may transmit an N4 session deletion request message to the source RAG 200-1. The SMF 160 may request release of a connection previously established between the source RAG 200-1 and the UPF anchor 220 by transmitting the N4 session deletion request message to the source RAG 200-1. According to an embodiment, the SMF 160 may receive an N4 session deletion response message from the source RAG 200-1. As the SMF 160 receives the N4 session deletion response message from the source RAG 200-1, the release of the connection between the source RAG 200-1 and the UPF anchor 220 may be considered complete. According to an embodiment, the AMF 150 may transmit a path switch request ACK message to the target CU-CP 117-2. According to an embodiment, the UPF anchor 220 may transmit an N3 end marker message to the source RAG 200-1. According to an embodiment, the source RAG 200-1 may transmit an N3 end marker message to the target RAG 200-2. The N3 end marker may denote the end of a payload stream in a tunnel of an N3 interface.

With reference to FIG. 9, a procedure for simplifying signaling of an initial access procedure in a core network, through an entity of the RAG 200 in which a UPF edge and a CU-UP are integrated, has been described. The IEs associated with the RAG 200 described above may be used not only for the above signaling, but also for the E1, N2 and N4 interfaces defined in 3GPP.

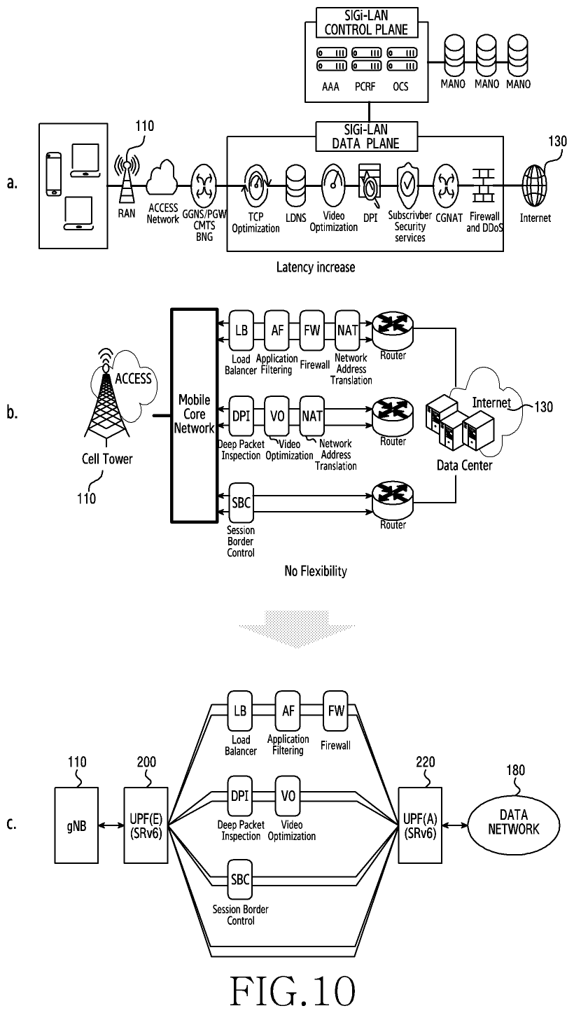

FIG. 10 illustrates an example of a Gi-local area network (LAN) service included in a UPF according to an embodiment of the disclosure.

A Gi-LAN may be referred to as a network in which service providers provide various self-developed and value-added services. According to various embodiments of the disclosure, by separating the UPF anchor 220 to reconfigure the user plane, numerous enterprise networks may be more simply connected to mobile networks. The UPF anchors 220 may be separated and deployed at the gate of each network as a more lightweight entity. The RAG may be configured to split the flow of traffic and deliver the same to the UPF anchor 220. According to an embodiment, customized security between the UPF edge and the UPF anchor 220 may also be provided through service function chaining.

According to various embodiments of the disclosure, the SRv6 tunnel 215 used for tunneling between the UPF anchor 220 and the UPF edge may facilitate service function chaining for Gi-LAN services. According to an embodiment, in the user plane structure reconstructed by introducing segment routing (SR), the UPF edge and the UPF anchor 220 may classify the flow of traffic based on policies received from the policy charging rules function (PCRF) and the SMF 160. After classifying the flow of traffic, the UPF edge and UPF anchor 220 may determine a target UPF node and an intermediate node through which the packet passes. According to an embodiment, the determined path may be encoded in each packet, and intermediate nodes may provide specific Gi-LAN services.

Referring to FIG. 10, in the case of approach ‘a’, an example in which all user traffic serially passes through the Gi-LAN server is shown. In the case of approach ‘a’, all user traffic passes through a series of Gi-LAN servers, resulting in latency increase. Referring to FIG. 10, in the case of approach ‘b’, an example of applying different service function chaining (SFC) for each access point name (APN) (i.e., for each router) is shown. In the case of approach ‘b’, by applying different SFCs based on APNs, the flexibility of traffic management may be reduced.

Referring to FIG. 10, in the case of the approach ‘c’, an example of using the SRv6 tunnel 215 by separating the UPF anchor 220 is shown. According to various embodiments of the disclosure, a new structure with introduction of the SRv6 tunnel 215 allows only selected traffic to pass through a required Gi-LAN server. According to an embodiment, different SFCs may be applied for each user or each application. Profits may be created from value-added services for each user or application, and capital expenditures (CapEx) may be reduced because Gi-LAN servers may be deployed adaptively by capacity. More specifically, according to an embodiment, a communication service provider may save CapEx by not having to invest in full capacity to deploy a Gi-LAN server. According to an embodiment, packet performance in the network may also be improved because Gi-LAN service packets do not need to pass through the network quickly. More specifically, according to an embodiment, a communication service provider may provide a new value-added service based on a terminal or an application, such as a video optimization service, a transmission control protocol (TCP) optimization service, and a subscriber-based security service.

A method performed by a session management function (SMF) device in a wireless communication system according to embodiments of the disclosure may include receiving, by the SMF device, a protocol data unit (PDU) session setup request message from an access and mobility management function (AMF), transmitting, by the SMF device, a PDU session setup response message to the AMF, transmitting, by the SMF device, a first session setup request message to a user plane function (UPF) anchor, receiving, by the SMF device, a first session setup response message from the UPF anchor, transmitting, by the SMF device, a second session setup request message to a radio access gateway (RAG), and receiving, by the SMF device, a second session setup response message from the RAG, wherein the RAG includes a central unit (CU)-user plane (UP) and a UPF edge.

According to an embodiment of the disclosure, the method may further include transmitting a session modification request message to the UPF anchor and receiving a session modification response message from the UPF anchor.

According to an embodiment of the disclosure, the method may further include receiving a PDU session update request message from the AMF, transmitting a third session setup request message to the target RAG, receiving a third session setup response message from the target RAG, transmitting a session modification request message to the UPF anchor, receiving a session modification response message from the UPF anchor, and transmitting a PDU session update response message to the AMF.

According to an embodiment of the disclosure, the method may further include transmitting a session deletion request message to a source RAG, and receiving a session deletion response message from the source RAG.

According to an embodiment of the disclosure, the PDU session setup request message may include information capable of accessing the RAG.

According to an embodiment of the disclosure, the first session setup response message may include at least one of information on an internet protocol (IP) address of a terminal or information of a tunnel connected between the RAG and the UPF anchor.

According to an embodiment of the disclosure, the second session setup response message may include context information about the terminal, information of a tunnel connected between the RAG and the UPF anchor, or information on a tunnel endpoint identifier (TEID) of the RAG.

According to an embodiment of the disclosure, the PDU session update request message may include information on a TEID generated by the target RAG.

According to an embodiment of the disclosure, the third session setup request message may include at least one of information of a tunnel connected between the target RAG and the UPF anchor and information on a TEID generated by the target RAG.

According to an embodiment of the disclosure, the session modification request message may include a message requesting to generate a tunnel connected between the target RAG and the UPF anchor.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. Furthermore, a plurality of such memories may be included in the electronic device.

In addition, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a session management function (SMF) entity in a wireless communication system, the method comprising:
receiving a protocol data unit (PDU) session setup request message from an access and mobility management function (AMF) entity;
transmitting a PDU session setup response message to the AMF entity;
transmitting a first session setup request message to a user plane function (UPF) anchor entity;
receiving a first session setup response message from the UPF anchor entity;
transmitting a second session setup request message to a radio access gateway (RAG) entity; and
receiving a second session setup response message from the RAG entity,
wherein the RAG entity comprises a central unit (CU)-user plane (UP) and a UPF edge.

2. The method of claim 1, further comprising:
transmitting a session modification request message to the UPF anchor entity; and
receiving a session modification response message from the UPF anchor entity.

3. The method of claim 1, further comprising:
receiving a PDU session update request message from the AMF entity;
transmitting a third session setup request message to a target RAG entity;
receiving a third session setup response message from the target RAG entity;
transmitting a session modification request message to the UPF anchor entity;
receiving a session modification response message from the UPF anchor entity; and
transmitting a PDU session update response message to the AMF entity.

4. The method of claim 3, further comprising:
transmitting a session deletion request message to a source RAG entity; and
receiving a session deletion response message from the source RAG entity.

5. The method of claim 1, wherein the PDU session setup request message comprises information capable of accessing the RAG entity.

6. The method of claim 1, wherein the first session setup response message comprises at least one of information on an internet protocol (IP) address of a terminal or information of a tunnel connected between the RAG entity and the UPF anchor entity.

7. The method of claim 1, wherein the second session setup response message comprises at least one of context information about a terminal, information of a tunnel connected between the RAG entity and the UPF anchor entity, or information on a tunnel endpoint identifier (TEID) of the RAG entity.

8. The method of claim 3, wherein the PDU session update request message comprises information on a TEID generated by the target RAG entity.

9. The method of claim 3, wherein the third session setup request message comprises at least one of information of a tunnel connected between the target RAG entity and the UPF anchor entity, and information on a TEID generated by the target RAG entity.

10. The method of claim 3, wherein the session modification request message comprises a message requesting to generate a tunnel connected between the target RAG entity and the UPF anchor entity.

11. An apparatus performed by a session management function (SMF) entity in a wireless communication system, the apparatus comprising:
a transceiver; and
a controller coupled to the transceiver and configured to:
receive a protocol data unit (PDU) session setup request message from an access and mobility management function (AMF) entity,
transmit a PDU session setup response message to the AMF entity,
transmit a first session setup request message to a user plane function (UPF) anchor entity,
receive a first session setup response message from the UPF anchor entity,
transmit a second session setup request message to a radio access gateway (RAG) entity, and
receive a second session setup response message from the RAG entity, and
wherein the RAG entity comprises a central unit (CU)-user plane (UP) and a UPF edge.

12. The SMF entity of claim 11, wherein the controller is further configured to:
transmit a session modification request message to the UPF anchor entity, and
receive a session modification response message from the UPF anchor entity.

13. The SMF entity of claim 11, wherein the controller is further configured to:
receive a PDU session update request message from the AMF entity,
transmit a third session setup request message to a target RAG entity,
receive a third session setup response message from the target RAG entity,
transmit a session modification request message to the UPF anchor entity,
receive a session modification response message from the UPF anchor entity, and
transmit a PDU session update response message to the AMF entity.

14. The SMF entity of claim 13, wherein the controller is further configured to:
transmit a session deletion request message to a source RAG entity, and
receive a session deletion response message from the source RAG entity.

15. The SMF entity of claim 11, wherein the PDU session setup request message comprises information capable of accessing the RAG entity.

16. The SMF entity of claim 11, wherein the first session setup response message comprises at least one of information on an Internet protocol (IP) address of a terminal or information of a tunnel connected between the RAG entity and the UPF anchor entity.

17. The SMF entity of claim 11, wherein the second session setup response message comprises at least one of context information about a terminal, information of a tunnel connected between the RAG entity and the UPF anchor entity, or information on a tunnel endpoint identifier (TEID) of the RAG entity.

18. The SMF entity of claim 13, wherein the PDU session update request message comprises information on a TEID generated by the target RAG entity.

19. The SMF entity of claim 13, wherein the third session setup request message comprises at least one of information of a tunnel connected between the target RAG entity and the UPF anchor entity, and information on a TEID generated by the target RAG entity.

20. The SMF entity of claim 13, wherein the session modification request message comprises a message requesting to generate a tunnel connected between the target RAG entity and the UPF anchor entity.
